(19) United States
(12) Patent Application Publication
(10) Pub. No.: US 2016/0288968 A1
(43) Pub. Date: Oct. 6, 2016

(54) UNSEALING INDICATION STRUCTURE OF COUNTERFEIT TAPE

(71) Applicant: SEAL KING INDUSTRIAL CO., LTD., Tao Yuan City (TW)

(72) Inventor: CHUNG CHIN WANG, TAO YUAN CITY (TW)

(21) Appl. No.: 15/070,465

(22) Filed: Mar. 15, 2016

(30) Foreign Application Priority Data
Mar. 31, 2015 (TW) 104204875

(51) Int. Cl. B65D 55/06; G01D 13/00

(52) U.S. Cl. CPC B65D 55/06; G01D 13/00

(57) ABSTRACT

An unsealing indication structure of a counterfeit tape includes: a substrate layer, being a plastic sheet; and an adhesive layer, adhered to the backside of the substrate layer. The adhesive layer is adhered to a sealed object and has a tensile tension smaller than an adhesive force between the adhesive layer and the sealed object, so that when an external force greater than the adhesive force is acted between the adhesive layer and the sealed object, the substrate layer is deformed to produce a wrinkle, and the unsealed counterfeit tape shows a multi-indication status and provides an excellent effect of observability. In addition, no substance or mark of the adhesive remains on the sealed object, and the unsealed counterfeit tape may be adhered to the sealed object again for further use after it is torn and opened, so as to provide a convenient and economic sealing operation.

### FIELD OF THE INVENTION

The present invention relates to a tape structure and more particularly to an indication structure capable of indicating whether or not a sealing tape has been torn and opened to observe the security condition of the sealed tape.

### BACKGROUND OF THE INVENTION

A tape is generally used for sealing an opening of a bag that contains a confidential object or document. In addition, when a container (such as a desk, a cabinet, or a box) containing important and confidential objects is transported or packed, but the container cannot be locked by locks, the opening or cover of the container is sealed by a tape in order to prevent the opening or cover of the container from being opened arbitrarily or inadvertently.

With reference to FIGS. 1A to 1E for the structure and using status of the traditional counterfeit tapes of this sort, the counterfeit tape 90 as shown in FIG. 1A comprises a substrate layer 91, an adhesive layer 92, and an anti-adhesive layer 93 which are combined with one another, wherein the anti-adhesive layer 93 is a release paper. During use (as shown in FIG. 1B), the anti-adhesive layer 93 is torn away, so that the adhesive layer 92 is adhered to an opening of a sealed object 94 such as a bag or any other object. In FIG. 1C, although the adhesive layer 92 is adhered to the sealed object 94 for sealing, the adhesive layer 92 (including the substrate layer 91) may be stuck back after being torn away. In FIG. 1D, after the counterfeit tape 90 is torn and stuck back again, the structural layers including the substrate layer 91 and the adhesive layer 92 do not have any change or abnormal situation. With reference to FIG. 1E for the top view of the substrate layer 91, no other mark or abnormal condition is found on the surface of the substrate layer 91, so that the counterfeit tape is unable to provide the effects of fully protect the confidentiality of the aforementioned document or object and may even miss the best timing for instant accountability and handling. Obviously, such design is not good for the structure of counterfeit tapes.

To overcome the aforementioned drawbacks of the traditional counterfeit tape, the present invention provides a counterfeit tape that can check the unsealing status of the tape, and the conventional counterfeit tape of this sort generally has a coating layer with a counterfeit mark coated onto the backside of the substrate layer of the tape, and then an adhesive is coated onto the coating layer to form the counterfeit tape, and the material for making the counterfeit mark is different from the material for making the remaining coating layer other than the counterfeit mark, and the adhesiveness between the counterfeit mark and the adhesive is greater than the adhesiveness between the counterfeit mark and the tape substrate, so that after the counterfeit tape is torn away from the sealed object, the counterfeit mark together with the adhesive is adhered to the sealed object, but the substrate layer cannot be adhered to the sealed object. Such counterfeit tape has the following drawback. After the substrate layer is torn, the counterfeit mark and the adhesive are remained on the sealed object and must be removed afterward, so that it usually has trouble to a continual use. After the substrate layer is torn, the substrate layer usually cannot be adhered again, and thus losing the basic seal protection effect. For a continual use of the sealing effect, it is necessary to use another tape, and thus causing inconvenience and waste of resources. Obviously, such design is not good enough.

In the counterfeit tape structure capable of checking the unsealing status, after the counterfeit tape is torn away from the sealed object, the counterfeit mark is indicated in the counterfeit tape, and the counterfeit tape can still be adhered onto the sealed object for use. However, when such counterfeit tape structure is torn and adhered back onto the sealed object, the uppermost substrate layer does not have show any mark or abnormal situation, and the indication of the counterfeit mark may be considered as a decorative or reminder mark to users who are unfamiliar with such counterfeit tape structure, and such counterfeit tape structure fails to provide a good observability for unfamiliar users and definitely requires further improvements. Therefore, it is an important subject for related manufacturers to overcome the drawbacks of the conventional counterfeit tape.

In view of the aforementioned drawbacks of the application and the structural design of the conventional counterfeit tape, the inventor of the present invention based on years of experience in the related industry to conduct extensive researches and experiments, and finally designed and developed the unsealing indication structure of a counterfeit tape with the features of multiple indication, obvious observation, and convenient application to overcome the drawbacks of the prior art.

### SUMMARY OF THE INVENTION

In view of the aforementioned problems of the prior art, it is a primary objective of the present invention to overcome the aforementioned problems by providing an unsealing indication structure of a counterfeit tape, wherein after the counterfeit tape is torn open, the substrate layer clearly indicates the unsealed status and no substance or mark of the adhesive remains on the sealed object, and such structure provides excellent observability and convenient application.

Another objective of the present invention is to provide an unsealing indication structure of a counterfeit tape, and the structure provides a multi-indication of the unsealed status after the counterfeit tape is torn or opened, so as to provide the effect of a simple and easy observation.

A further objective of the present invention is to provide an unsealing indication structure of a counterfeit tape, so that after the counterfeit tape has been torn and opened, the counterfeit tape may be adhered onto the sealed object again for further use, so as to provide the protection, convenient application, and economic use for the sealing operation.

To achieve the aforementioned and other objectives, the present invention provides an unsealing indication structure of a counterfeit tape, comprising: a substrate layer, being a plastic sheet; and an adhesive layer, adhered to the backside of the substrate layer; wherein the adhesive layer is adhered and attached onto a sealed object, and the substrate layer has a tensile tension smaller than an adhesive force between the adhesive layer and the sealed object, such that when an external force greater than the adhesive force is acted between the adhesive layer and the sealed object, the substrate layer is deformed to form a wrinkle.

Wherein, the backside of the adhesive layer includes an anti-adhesive layer.

The unsealing indication structure of a counterfeit tape in accordance with another embodiment of the present invention comprises: a substrate layer, being a plastic sheet; a non-transfer indication assembly, adhered to the backside of the substrate layer; and an adhesive layer, adhered to the other plane surface of the non-transfer indication assembly opposite to the substrate layer; wherein the adhesive layer is adhered and attached onto a sealed object, and the substrate layer has a tensile tension smaller than an adhesive force between the adhesive layer and the sealed object, such that when an external force greater than the adhesive force is acted between the adhesive layer and the sealed object, the substrate layer is deformed to form a wrinkle.

Wherein, the non-transfer indication assembly comprises a printing layer, a color fixing layer and a non-release layer, and the printing layer is printed or coated onto the backside of the substrate layer, and the color fixing layer is coated onto the topside of the printing layer and the backside of the substrate layer including a gap between the printing layer and the substrate layer, and the non-release layer is coated onto the color fixing layer, and the non-release layer is disposed on the topside of the adhesive layer.

Wherein, the printing layer adopts a resin with the same color and transparency of the substrate layer and the adhesiveness with the substrate layer to print a Chinese or English word of “has been unsealed”, a torn mark including a pattern or a symbol onto the backside of the substrate layer by any printing technology, and the color fixing layer adopts an ink of a color with an appropriate difference from the substrate layer and the printing layer.

Wherein, the color fixing layer and the printing layer have an adhesive force smaller than the adhesive force of the color fixing layer and the substrate layer, so that when a tearing force is applied, the color fixing layer is separated from the printing layer but is still adhered to the backside of the substrate layer, and the adhesive layer is an adhesive which may be adhered repeatedly for use.

The unsealing indication structure of a counterfeit tape in accordance with another embodiment of the present invention comprises: a substrate layer, being a plastic sheet; a printing layer, printed or coated on the backside of the substrate layer; a color fixing layer, coated on the topside of the printing layer, and the backside of the substrate layer including a gap between the substrate layer and the printing layer; a film adhering layer, coated on the color fixing layer; and an adhesive layer, disposed on the backside of the film adhering layer; wherein the adhesive layer is adhered to a sealed object, and the printing layer and the color fixing layer have an adhesive force smaller than adhesive force of the substrate layer and the printing layer, and the printing layer and the color fixing layer have an adhesive force smaller than the adhesive force of the film adhering layer and the color fixing layer, and the substrate layer and the color fixing layer have an adhesive force greater than the adhesive force of the film adhering layer and the color fixing layer, and the substrate layer has a tensile tension smaller than the adhesive force of the film adhering layer and the color fixing layer, or the substrate layer has a tensile tension smaller than the adhesive force of the printing layer and the color fixing layer.

Wherein, the printing layer adopts a resin with the same color and transparency of the substrate layer and the adhesiveness with the substrate layer to print a Chinese or English word of “has been unsealed”, a torn mark including a pattern or a symbol onto the backside of the substrate layer by any printing technology.

Wherein, an action force applying to the tape is acted onto the color fixing layer through the film adhering layer, so that the color fixing layer produces an action force to separate the substrate layer, and a part of the color fixing layer in the gap between the printing layer and the printing layer is separated with the substrate layer, and the color fixing layer on the printing layer is separated from the printing layer and remained on the film adhering layer, and the film adhering layer is adhered to the sealed object by the action of the adhesive layer.

### BRIEF DESCRIPTION OF THE DRAWINGS

FIGS. 1A-1E are schematic views of a conventional counterfeit tape structure and its using status;

FIG. 2A is a sectional view of a counterfeit tape with an unsealing indication structure in accordance with a first preferred embodiment of the present invention;

FIG. 2B is a sectional view of sticking and using a counterfeit tape with an unsealing indication structure in accordance with the first preferred embodiment of the present invention;

FIG. 2C is a sectional view of a counterfeit tape with an unsealing indication structure while being torn in accordance with the first preferred embodiment of the present invention;

FIG. 2D is a sectional view of a counterfeit tape with an unsealing indication structure after being torn away in accordance with the first preferred embodiment of the present invention;

FIG. 2E is a top view of the surface of a substrate layer of FIG. 2D;

FIG. 3A is a sectional view of a counterfeit tape with an unsealing indication structure in accordance with a second preferred embodiment of the present invention;

FIG. 3B is a sectional view of sticking and using a counterfeit tape with an unsealing indication structure in accordance with the second preferred embodiment of the present invention;

FIG. 3C is a top view of the surface of a substrate layer of FIG. 3B;

FIG. 3D is a sectional view of a counterfeit tape with an unsealing indication structure while being torn in accordance with the second preferred embodiment of the present invention;

FIG. 3E is a sectional view of a counterfeit tape with an unsealing indication structure after being torn away and then stuck back again in accordance with the second preferred embodiment of the present invention;

FIG. 3F is a top view of the surface of a substrate layer of FIG. 3D;

FIG. 4A is a sectional view of a counterfeit tape with an unsealing indication structure in accordance with a third preferred embodiment of the present invention;

FIG. 4B is a sectional view of sticking and using a counterfeit tape with an unsealing indication structure in accordance with a third preferred embodiment of the present invention;

FIG. 4C is a top view of the surface of a substrate layer of FIG. 4B;

FIG. 4D is a sectional view of a counterfeit tape with an unsealing indication structure while being torn in accordance with the third preferred embodiment of the present invention;

FIG. 4E is a sectional view of a counterfeit tape with an unsealing indication structure after being torn away in accordance with the third preferred embodiment of the present invention;

FIG. 4F is a top view of the status of a substrate layer after an unsealing indication structure is torn away in accordance with the third preferred embodiment of the present invention;

FIG. 4G is a top view of an unsealing indication structure after being torn away and remaining on a sealed object in accordance with a third preferred embodiment of the present invention.

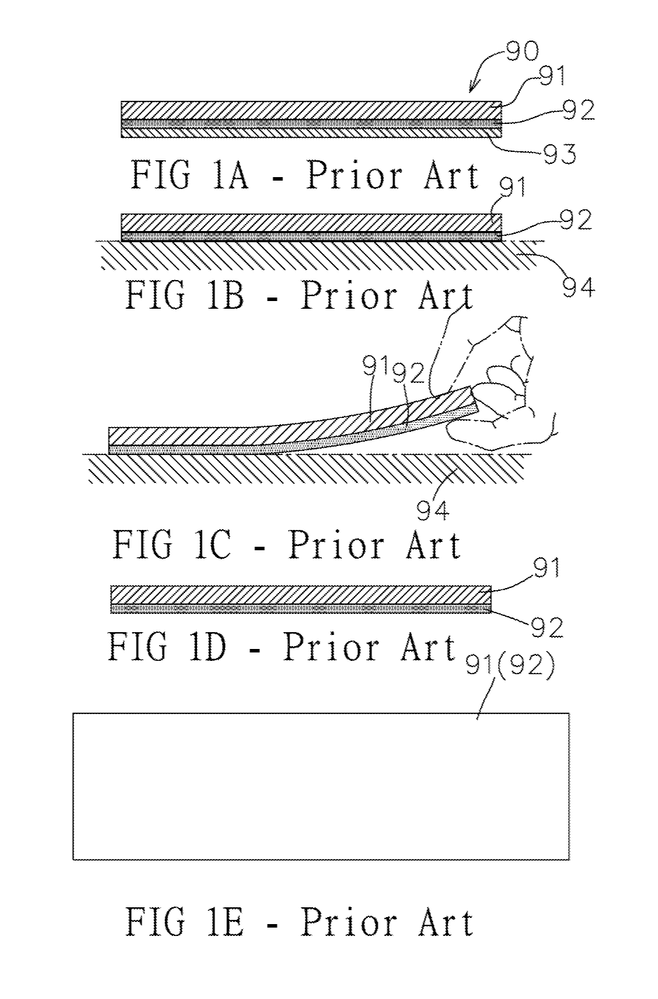

### DESCRIPTION OF THE PREFERRED EMBODIMENTS

The technical characteristics, contents, advantages and effects of the present invention will be apparent with the detailed description of a preferred embodiment accompanied with the illustration of related drawings as follows.

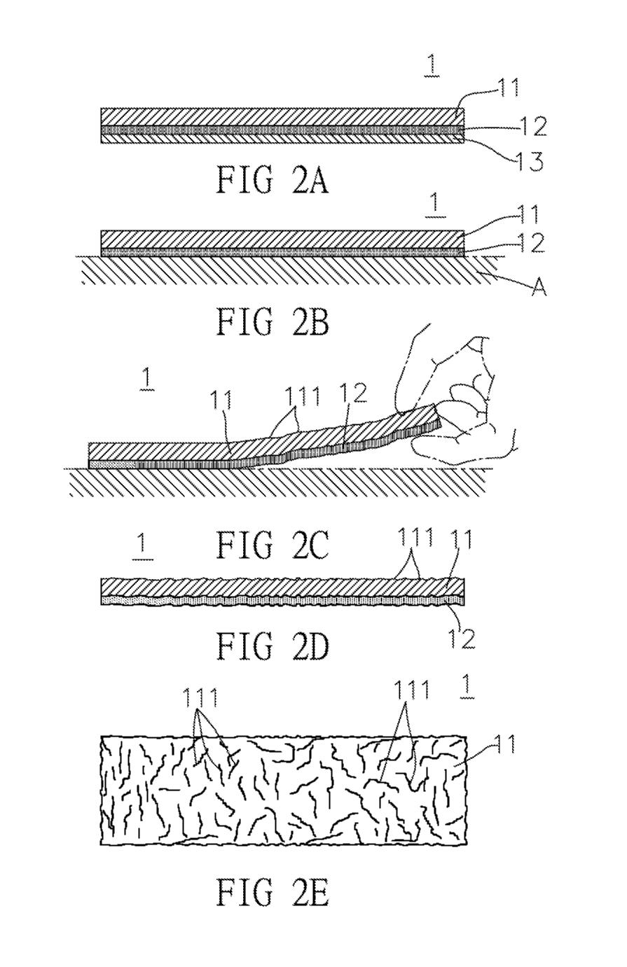

With reference to FIG. 2A for an unsealing indication structure of a counterfeit tape in accordance with the first preferred embodiment of the present invention, the counterfeit tape 1 comprises a substrate layer 11 made of a plastic sheet, and the substrate layer 11 is made of a material including but not limited to PE, PU+PE, LLPE, HPE or LPE, etc and the substrate layer 11 is a transparent, semi-transparent, or color film, and whose elasticity may be set according to user requirements, but the invention is not limited to such arrangement only; the backside of the substrate layer 11 includes an adhesive layer 12, and the backside of the adhesive layer 12 includes an anti-adhesive layer 13, and the anti-adhesive layer 13 is a release paper. With reference to FIG. 2B for the use of the counterfeit tape 1, the anti-adhesive layer 13 is torn away, and the adhesive layer 12 is adhered to a sealed object A for sealing an opening or a sealing position of the sealed object A such as a bag or any other object. Wherein, the substrate layer 11 has a tensile tension smaller than an adhesive force between the adhesive layer 12 and the sealed object A, so that when an external force (such as a tearing force) greater than the adhesive force is applied between the adhesive layer 12 and the sealed object A, the external force is also greater than the tensile tension of the substrate layer 11, so that the substrate layer 11 is deformed by the external force to produce a wrinkle.

With reference to FIG. 2C for the sealed object A while being torn away from the adhesive layer 12, the tearing force must be greater than the adhesive force between the adhesive layer 12 and the sealed object A in order to tear the tape, and the tearing force for tearing away the tape is greater than the tensile tension of the substrate layer 11, so that the substrate layer 11 is deformed to produce a wrinkle 111 as shown in FIGS. 2D and 2E. Since the tensile tension of the substrate layer 11 is reduced to cause a deformation that produces the wrinkle 111 and unable to remove the wrinkle 111 or resume the original flat and smooth condition (irreversible), therefore the wrinkle 111 cannot be removed even after the adhesive layer 12 is torn away and adhered to the sealed object A again, and the substrate layer 11 clearly indicates the unsealed status. Such design provides a convenient visual inspection with high accuracy and observability.

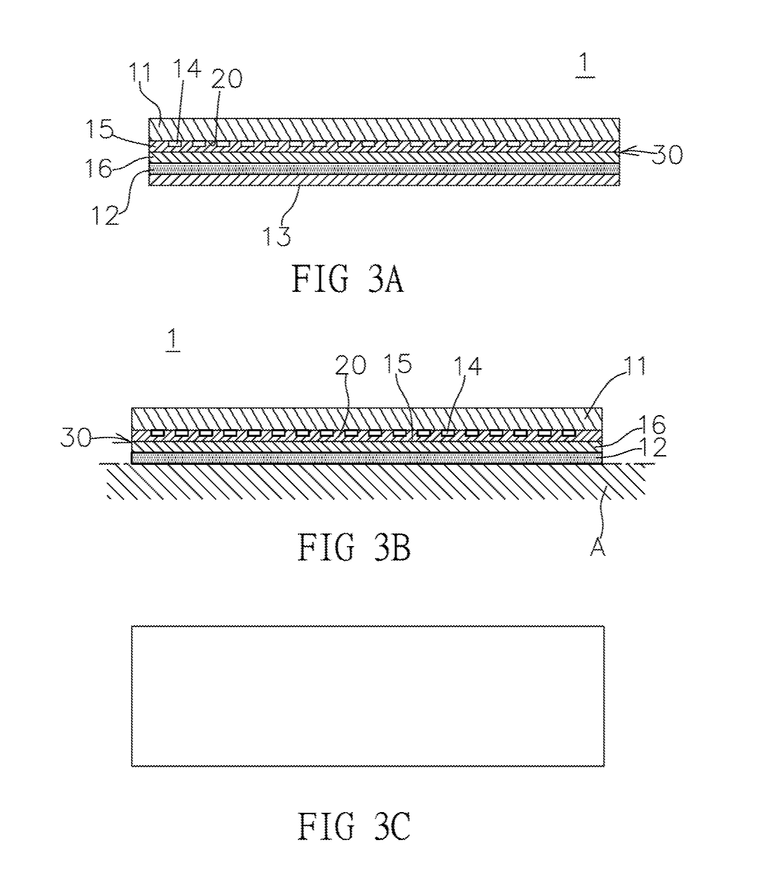

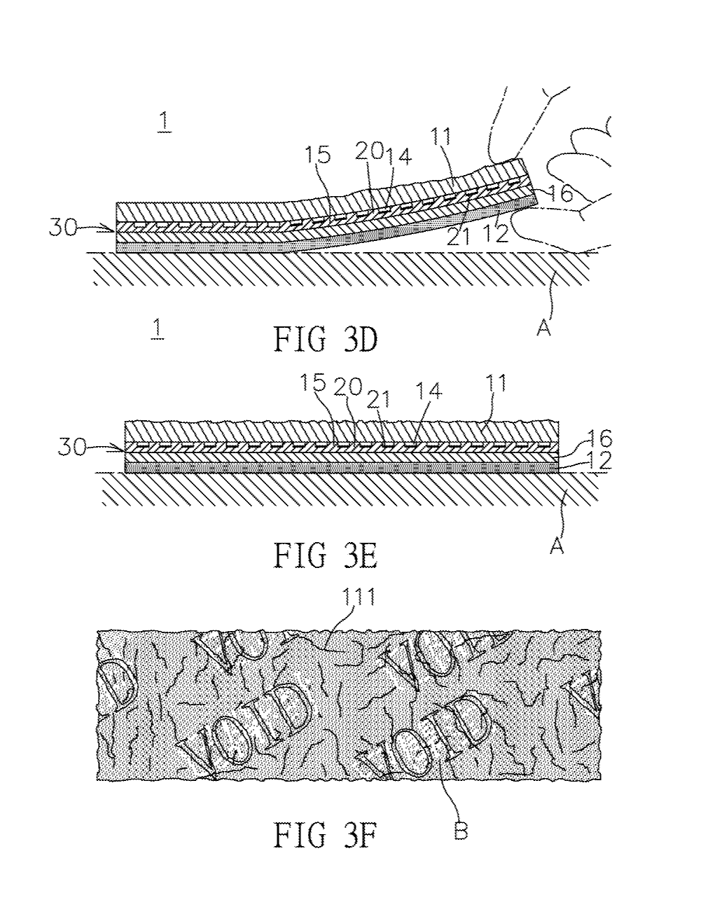

With reference to FIG. 3A for an unsealing indication structure of a counterfeit tape in accordance with the second preferred embodiment of the present invention, the second preferred embodiment is based on the first preferred embodiment that uses the assembly of the substrate layer and the basic structure to produce the wrinkle 111 on the substrate layer by the tearing force to make modifications, and the difference between the first and second embodiments resides on that the counterfeit tape 1 further comprises a non-transfer indication assembly 30 installed between the substrate layer 11 and the adhesive layer 12, and the non-transfer indication assembly 30 comprises a printing layer 14, a color fixing layer 15 and a non-release layer 16; wherein the printing layer 14 is printed or coated onto the backside of the substrate layer 11, and the color fixing layer 15 is coated onto the topside of the printing layer 14 and the backside of the substrate layer 11 including a gap 20 in the printing layer 14, and the non-release layer 16 is coated onto the color fixing layer 15, and the non-release layer 16 is disposed on the topside of the adhesive layer 12, and the backside of the adhesive layer 12 also includes the anti-adhesive layer 13.

The printing layer 14 adopts a resin with the same color and transparency of the substrate layer 11 and the adhesiveness with the substrate layer 11 to print a torn mark such as Chinese or English words of “has been unsealed”, a pattern or a symbol by the printing technology on the backside of the substrate layer 11. The color fixing layer 15 adopts an ink of a color with an appropriate difference from the substrate layer 11 and the printing layer 14, wherein the so-called appropriate difference refers to the clarity of indicating the unsealed status of an object according to the object with the counterfeit tape 1 or a using unit. For example, the colors of the substrate layer 11 and the printing layer 14 have greater contrast to provide a more significant effect of indicating an unsealed status. If it is necessary to prevent others from knowing the unsealed status, the colors with smaller contrast will be adopted. In addition, the color fixing layer 15 and the printing layer 14 have an adhesive force smaller than the adhesive force of the color fixing layer 15 and the backside of the substrate layer 11, and the ink of the color fixing layer 15 is coated onto a gap 20 between the backside of the substrate without having the printing layer and the printing layer 14 in addition to the words, pattern, or symbol printed on the printing layer 14, such that when the counterfeit tape is torn and opened, the color fixing layer 15 and the printing layer 14 are separated from each other, but are still adhered to the backside of the substrate layer 11, so that the ink of the color fixing layer 15 is used as a background color for contrast, and the printing layer 14 separated from the ink can be observed from the surface of the substrate layer 11.

In addition, the non-release layer 16 coated on the color fixing layer 15 is made medium material provided for applying the ink of the color fixing layer 15 appropriately to form the adhesive layer 12, so that the adhesive layer 12 and the color fixing layer 15 can be combined as a whole by a strong adhesive force. The adhesive layer 12 is primarily provided for attaching the counterfeit tape to the sealed object A, wherein the adhesive may adopt a general conventional material, but the present invention preferably adopts a material that will not be adhered to the adhesive layer after the counterfeit tape is torn, and the material can be adhered to the sealed object again. In other words, the adhesive layer is an adhesive that can be adhered and used repeatedly.

With reference to FIG. 3B for the use of a counterfeit tape of the present invention which is similar to the use of a general tape, an anti-adhesive layer 13 is torn away first and then attached to a sealed object A. Now, the surface of the counterfeit tape (or the substrate layer 11) as shown in FIG. 3C shows that the color of the torn mark on the printing layer 14 is the same as the color of other parts. In other words, the surface just shows a single color of the color fixing layer 15 and does not indicate any existing label that is not torn.

In FIG. 3D, if the adhesive layer 12 is torn away from the sealed object A with or without authorization as shown in FIG. 3E, the adhesive force of the adhesive layer 12 imposed on the sealed object A is acted onto the color fixing layer 15 through the non-release layer 16, so that the color fixing layer 15 has an action force to separate the printing layer 14 and the substrate layer 11 simultaneously, but the adhesive force of the color fixing layer 15 imposed on the substrate layer 11 is greater than the adhesive force imposed on the printing layer 14, so that the color fixing layer 15 and the printing layer 14 are pulled to form a gap 21 between the color fixing layer 15 and the printing layer 14, and the color fixing layer 15 and the substrate layer 11 still remain adhered closely to each other. In other words, the adhesive force of the adhesive layer 12 imposed on the color fixing layer 15 is greater than the adhesive force of the color fixing layer 15 imposed on the printing layer 14 but is smaller than the adhesive force of the color fixing layer 15 imposed on the substrate layer 11. Therefore, the surface of the substrate layer 11 shows that the torn label B of the printing layer 14 is shown completely by the aforementioned gap 21, and the color here is the color of the substrate layer 11 (as shown in FIG. 3F). In the meantime, the substrate layer 11 has a tensile tension smaller than the adhesive force between the adhesive layer 12 and the sealed object A. Since the tearing force of the counterfeit tape must be greater than the adhesive force between the adhesive layer 12 and the sealed object A to tear away the counterfeit tape, therefore the tearing force for tearing away the counterfeit tape is also greater than the tensile tension of the substrate layer 11, and the substrate layer 11 is deformed to produce a wrinkle 111 as shown in FIGS. 3D and 3F. Now, even if the torn counterfeit tape is adhered back to the sealed object A again (as shown in FIG. 3E) to cover up the fact of tearing the counterfeit tape or continue to provide the sealing effect of the tape, a torn mark B and a wrinkle 111 are formed on the surface of the substrate layer 11, and the torn mark B and wrinkle 111 are two obvious ways to tell that the counterfeit tape has been torn, and the original sealed status cannot be resumed, and the unsealed status can be observed easily.

Since the adhesive layer 12 is made of an adhesive that will not remain on the sealed object after the counterfeit tape is torn, therefore after the counterfeit tape is torn and opened, it is not necessary to clean the sealed object A. Although the counterfeit tape indicates the unsealed status after it is torn and opened, the counterfeit tape can be adhered back to the sealed object again for the basic sealing and protecting functions.

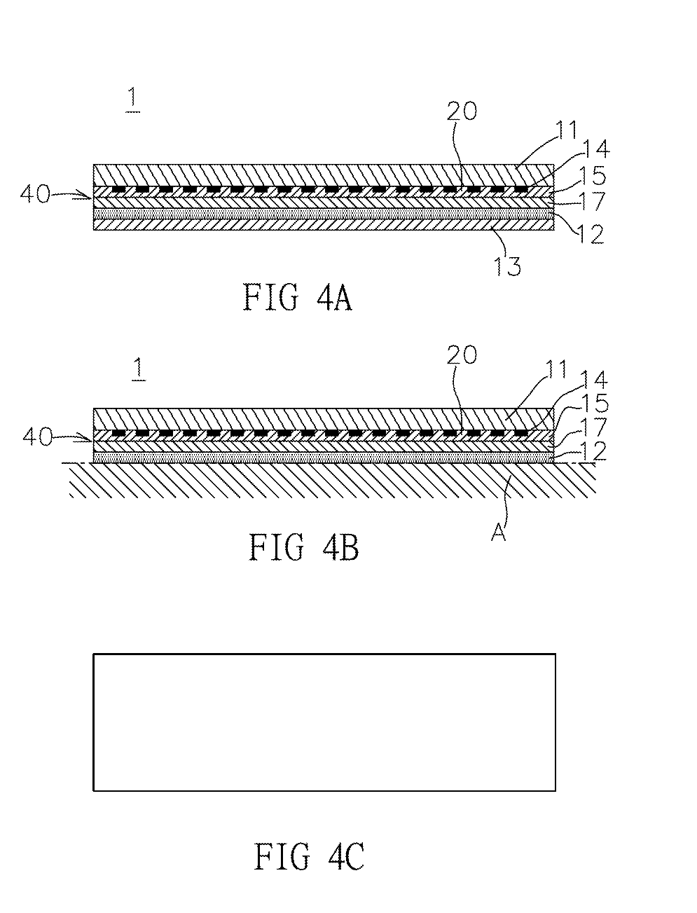

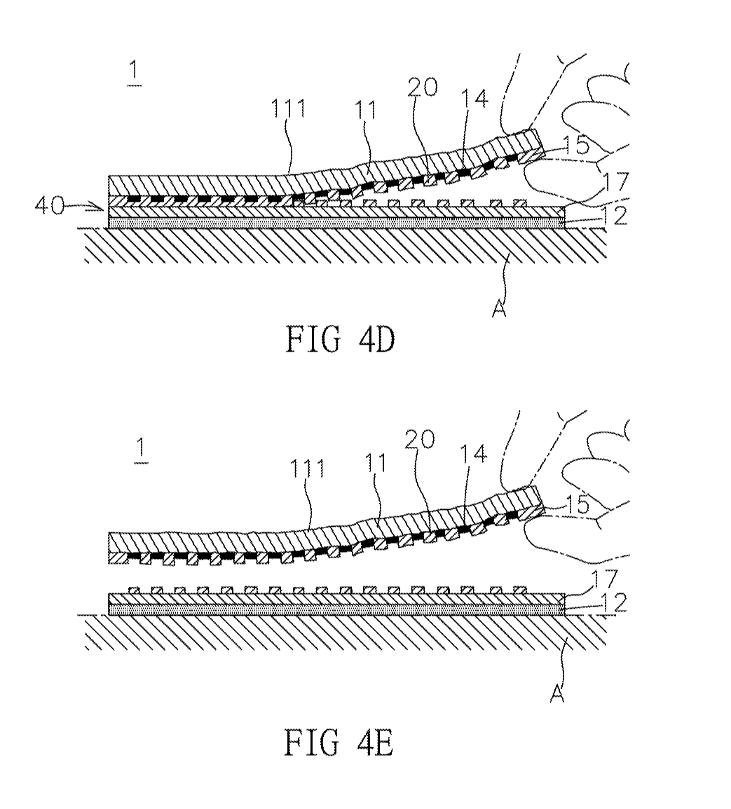

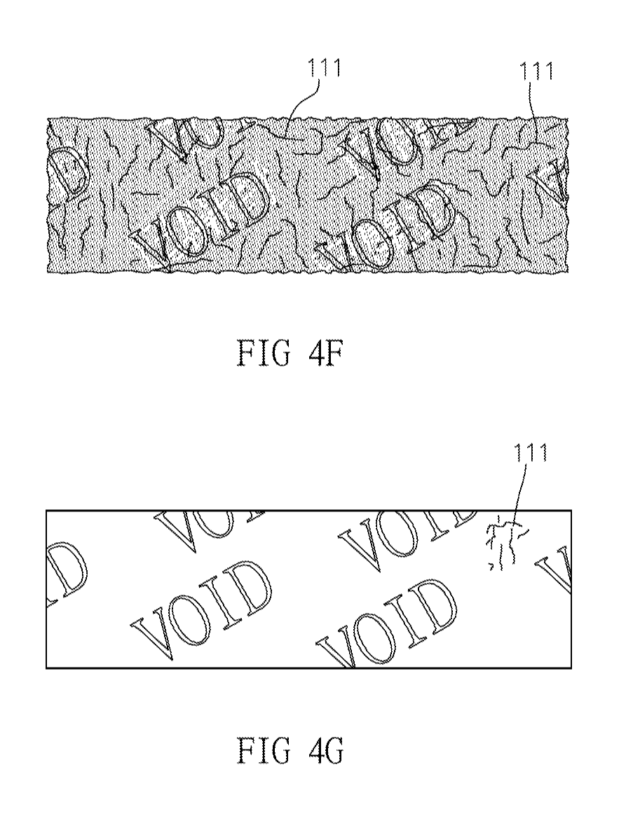

With reference to FIG. 4A for an unsealing indication structure of a counterfeit tape in accordance with the third preferred embodiment of the present invention, this preferred embodiment is substantially the same as the first preferred embodiment, wherein the substrate layer produces a tearing force to form the wrinkle 111 on the substrate layer, and such structure is modified. Their difference resides on that the counterfeit tape 1 further comprises a transfer indication assembly 40 installed between the substrate layer 11 and the adhesive layer 12, and the transfer indication assembly 40 comprises a printing layer 14, a color fixing layer 15 and a film adhering layer 17, wherein the printing layer 14 is printed or coated on the backside of the substrate layer 11, and the color fixing layer 15 is coated on the topside of the printing layer 14 and the backside of the substrate layer 11 including the gap 20 in the printing layer 14, and the film adhering layer 17 is coated on the color fixing layer 15, and the backside of the film adhering layer 17 includes the adhesive layer 12, and the backside of the adhesive layer 12 includes the anti-adhesive layer 13.

The printing layer 14 is made of a resin material having the same color and transparency of the substrate layer 11 and an adhesiveness with the substrate layer 11, and a torn mark such as Chinese or English words “has been unsealed”, a pattern, or a symbol is printed on the backside of the substrate layer 11 by any printing technology. The color fixing layer 15 adopts an ink with an appropriate color different from the colors of the substrate layer 11 and the printing layer 14, such that after the substrate layer 11 is torn away, the unsealed status is indicated obviously and can be observed easily. The film adhering layer 17 is a film, such that after the substrate layer 11 is torn away from the counterfeit tape 1, the color fixing layer 15 (or the ink) coated on the printing layer 14 is remained on the printing layer 14, and still adhered to the sealed object A by the film adhering layer 17, so as to maintain the sealing effect.

With reference to FIG. 4B for the application of a counterfeit tape 1 of the present invention similar to the application of a general conventional tape, the counterfeit tape 1 is cut with an appropriate length and adhered to a sealed object A. Now, the surface of the counterfeit tape 1 (as shown in FIG. 4C) just shows a single color of the color fixing layer 15 only and does not show the torn mark.

Wherein, the adhesive force of the printing layer 14 imposed on the color fixing layer 15 is smaller than the adhesive force of the substrate layer 11 imposed on the printing layer 14, and the adhesive force of the printing layer 14 imposed on the color fixing layer 15 is also smaller than the adhesive force of the film adhering layer 17 imposed on the color fixing layer 15, and the adhesive force of the substrate layer 11 imposed on the color fixing layer 15 is greater than the adhesive force of the film adhering layer 17 imposed on the color fixing layer 15. In addition, the substrate layer 11 has a tensile tension smaller than the adhesive force of the film adhering layer 17 imposed on the color fixing layer 15, or the substrate layer 11 has a tensile tension smaller than the adhesive force of the printing layer 14 imposed on the color fixing layer 15.

With reference to FIGS. 4D and 4E, when the counterfeit tape is torn, the action force of the adhesive layer 12 imposed on the sealed object A is acted onto the color fixing layer 15 through the film adhering layer 17, so that the color fixing layer 15 has an action force to separate the substrate layer 11. Since the adhesive force of the substrate layer 11 imposed on the printing layer 14 is greater than the adhesive force of the printing layer 14 imposed on a portion of the printing layer 14, and the adhesive force of the printing layer 14 imposed on a portion of the color fixing layer 15 is smaller than the adhesive force of the film adhering layer 17 imposed on the portion of the color fixing layer 15, therefore when the counterfeit tape is torn, the portions of the printing layer 14 and the color fixing layer 15 in the gap 20 of the printing layer 14 twill be separated from the counterfeit tape with the substrate layer 11, and the color fixing layer 15 of the original printing layer 14 will be separated from the printing layer 14 and remained on the film adhering layer 17, and the film adhering layer 17 is still adhered to the sealed object A by the action force of the adhesive layer 12. Now, since the tearing force of the counterfeit tape is greater than the adhesive force of the film adhering layer 17 imposed on the color fixing layer 15, and the tearing force is also greater than the adhesive force of the printing layer 14 imposed on the color fixing layer 15, so that the tearing force is greater than the tensile tension of the substrate layer 11, and the substrate layer 11 is deformed by the action of the tearing force to produce a wrinkle 111.

In FIG. 4F, since just a portion of the color fixing layer 15 adhered onto the film adhering layer 17 of the sealed object A is remained on the original printing layer 14, a top view of the film adhering layer 17 shows that a torn mark including the words “has been unsealed”, a pattern or a symbol appears to indicate that the counterfeit tape has be torn away. In FIG. 4G, the portion of the color fixing layer 15 in the gap 20 of the printing layer 14 is torn away together with the substrate layer 11, and the surface of the substrate layer 11 shows a figure opposite to that of FIG. 4F. Beside the wrinkle 111 shown on the substrate layer 11, the top view of the substrate layer 11 and the film adhering layer 17 shows a torn mark including words “has been unsealed”, a pattern, or a symbol. The multiple of indications of the unsealed status allow users to observe the unsealed status easily. Even if the color fixing layer 15 and the film adhering layer 17 are adhered back to each other, and the original unsealed status cannot be resumed, an excellent sealing effect can be achieved.

Although the sealed status of the counterfeit tape is no longer maintained since the substrate layer 11 is torn away, the film adhering layer 17 is still adhered to the sealing opening of the sealed object A by the action force of the adhesive layer 12, and the sealing opening of the sealed object A is maintained to be sealed by the film adhering layer 17, so as to achieve another layer of sealing protection in addition to the substrate layer 11. If the counterfeit tape is torn or opened by accident, the sealing of the sealed object A is still maintained to provide protection to the sealing opening Unlike a general counterfeit tape, the confidentiality of the sealed object will be lost after the substrate layer is torn away. Therefore, this preferred embodiment provides double protections to the sealed object.

In addition, the substrate layer 11 of this preferred embodiment may be made of a color or semi-transparent plastic material, and the transparency and color of the printing layer 14 are not limited specifically. However, the colors of the color fixing layer 15 and the film adhering layer 17 must have a contrast, so that after the substrate layer 11 is torn away from the tape, the unsealed status can be observed easily.

The counterfeit tape structure of the present invention provides a way of checking the unsealed status of the counterfeit tape by a multiple of indications with excellent observability. In addition, the material or mark of the adhesive will not remain on the sealed object, and the counterfeit tape may be adhered back to the sealed object again after the tape is torn, so as to provide a convenient and economic sealing operation.

What is claimed is:

1. An unsealing indication structure of a counterfeit tape, comprising:
a substrate layer, being a plastic sheet; and
an adhesive layer, adhered to the backside of the substrate layer;
wherein the adhesive layer is adhered and attached onto a sealed object, and the substrate layer has a tensile tension smaller than an adhesive force between the adhesive layer and the sealed object, such that when an external force greater than the adhesive force is acted between the adhesive layer and the sealed object, the substrate layer is deformed to form a wrinkle.

2. The unsealing indication structure of a counterfeit tape according to claim 1, wherein the backside of the adhesive layer includes an anti-adhesive layer.

3. An unsealing indication structure of a counterfeit tape, comprising:
a substrate layer, being a plastic sheet;
a non-transfer indication assembly, adhered to the backside of the substrate layer; and
an adhesive layer, adhered to the other plane surface of the non-transfer indication assembly opposite to the substrate layer;
wherein the adhesive layer is adhered and attached onto a sealed object, and the substrate layer has a tensile tension smaller than an adhesive force between the adhesive layer and the sealed object, such that when an external force greater than the adhesive force is acted between the adhesive layer and the sealed object, the substrate layer is deformed to form a wrinkle.

4. The unsealing indication structure of a counterfeit tape according to claim 3, wherein the non-transfer indication assembly comprises a printing layer, a color fixing layer and a non-release layer, and the printing layer is printed or coated onto the backside of the substrate layer, and the color fixing layer is coated onto the topside of the printing layer and the backside of the substrate layer including a gap between the printing layer and the substrate layer, and the non-release layer is coated onto the color fixing layer, and the non-release layer is disposed on the topside of the adhesive layer.

5. The unsealing indication structure of a counterfeit tape according to claim 4, wherein the printing layer adopts a resin with the same color and transparency of the substrate layer and the adhesiveness with the substrate layer to print a Chinese or English word of “has been unsealed”, a torn mark including a pattern or a symbol onto the backside of the substrate layer by any printing technology, and the color fixing layer adopts an ink of a color with an appropriate difference from the substrate layer and the printing layer.

6. The unsealing indication structure of a counterfeit tape according to claim 5, wherein the color fixing layer and the printing layer have an adhesive force smaller than the adhesive force of the color fixing layer and the substrate layer, so that when a tearing force is applied, the color fixing layer is separated from the printing layer but is still adhered to the backside of the substrate layer, and the adhesive layer is an adhesive which may be adhered repeatedly for use.

7. An unsealing indication structure of a counterfeit tape, comprising:
a substrate layer, being a plastic sheet;
a printing layer, printed or coated on the backside of the substrate layer;
a color fixing layer, coated on the topside of the printing layer, and the backside of the substrate layer including a gap between the substrate layer and the printing layer;
a film adhering layer, coated on the color fixing layer; and
an adhesive layer, disposed on the backside of the film adhering layer;
wherein the adhesive layer is adhered to a sealed object, and the printing layer and the color fixing layer have an adhesive force smaller than adhesive force of the substrate layer and the printing layer, and the printing layer and the color fixing layer have an adhesive force smaller than the adhesive force of the film adhering layer and the color fixing layer, and the substrate layer and the color fixing layer have an adhesive force greater than the adhesive force of the film adhering layer and the color fixing layer, and the substrate layer has a tensile tension smaller than the adhesive force of the film adhering layer and the color fixing layer, or the substrate layer has a tensile tension smaller than the adhesive force of the printing layer and the color fixing layer.

8. The unsealing indication structure of a counterfeit tape according to claim 7, wherein the printing layer adopts a resin with the same color and transparency of the substrate layer and the adhesiveness with the substrate layer to print a Chinese or English word of “has been unsealed”, a torn mark including a pattern or a symbol onto the backside of the substrate layer by any printing technology.

9. The unsealing indication structure of a counterfeit tape according to claim 8, wherein an action force applying to the tape is acted onto the color fixing layer through the film adhering layer, so that the color fixing layer produces an action force to separate the substrate layer, and a part of the color fixing layer in the gap between the printing layer and the printing layer is separated with the substrate layer, and the color fixing layer on the printing layer is separated from the printing layer and remained on the film adhering layer, and the film adhering layer is adhered to the sealed object by the action of the adhesive layer.

10. The unsealing indication structure of a counterfeit tape according to claim 9, wherein the backside of the adhesive layer includes an anti-adhesive layer.
